(19) United States
(12) Patent Application Publication
(10) Pub. No.: US 2024/0254748 A1
(43) Pub. Date: Aug. 1, 2024

(54) AUGER TOOL

(71) Applicant: OLYMPIA TOOLS INTERNATIONAL, INC., Covina, CA (US)

(72) Inventors: Cecil WILSON, Sanford, NC (US); Roger Dale HURLEY, JR., Raleigh, NC (US); Jonathan S. BECKWITH, Durham, NC (US); Nicholas IMSAND, Huntersville, NC (US)

(21) Appl. No.: 18/429,033

(22) Filed: Jan. 31, 2024

Related U.S. Application Data
(60) Provisional application No. 63/442,241, filed on Jan. 31, 2023.

(51) Int. Cl. E03C 1/302; B08B 9/045

(52) U.S. Cl. CPC E03C 1/302; B08B 9/045; B08B 2209/04

(57) ABSTRACT

The present disclosure relates to auger tools and related methods for removing clogs in tubulars. In one or more embodiments, an auger tool includes a body with a semi-circular recess, an extendable cable stored in and rotatable with the body, a rotationally independent grip, and a crank assembly. The crank assembly also includes a crank arm and a crank handle. The crank arm is coupled by a pivotable coupling to a center of the body and configurable in a stowed position and a manually operational position. The crank handle is coupled to the crank arm. The crank arm is in the stowed position when the crank handle is disposed in the semi-circular recess of the body and the crank arm is in the manually operable position when the crank arm is pivoted 180 degrees from the stowed position and the crank handle extends axially from the body.

### CROSS-REFERENCE TO RELATED APPLICATION

This application claims the benefit of U.S. Provisional Application No. 63/442,241, filed Jan. 31, 2023, which is incorporated by reference herein in its entirety.

### BACKGROUND

### Field

The present disclosure relates to auger tools and methods for removing clogs from tubulars.

### Description of Related Art

Auger tools are well-known devices for reaching and removing clogs in pipes and other tubular members. While the basic arrangement of an auger tool is well known, there are a number of deficiencies in current models that can be improved with new and novel features.

### SUMMARY

The present disclosure relates to auger tools and related methods for removing clogs in tubulars. In one or more embodiments, an auger tool includes a body with a semi-circular recess, an extendable cable stored in and rotatable with the body, a rotationally independent grip, and a crank assembly. The crank assembly also includes a crank arm and a crank handle. The crank arm is coupled by a pivotable coupling to a center of the body and configurable in a stowed position and a manually operational position. The crank handle is coupled to the crank arm. The crank arm is in the stowed position when the crank handle is disposed in the semi-circular recess of the body and the crank arm is in the manually operable position when the crank arm is pivoted 180 degrees from the stowed position and the crank handle extends axially from the body.

According to some embodiments, the crank assembly of the auger tool includes a direct drive assembly including a hex bit disposed in a chuck sleeve and coupled to a retainer plate configured to receive rotational forces and transfer the rotational forces to the body.

According to some embodiments, the direct drive assembly of the auger tool is disposed in the center of the body and the crank arm of the auger tool includes a cut-out permitting the crank arm to pivot over an extrusion of the body housing the pivotable coupling and the direct drive assembly without interference.

According to some embodiments, the crank arm of the auger tool pivots between the stowed position and the manually operational position about an axis perpendicular to a centerline of the auger tool and the crank arm extends beyond an outer diameter of the body when the crank assembly is in the manually operational position.

According to some embodiments, the body of the auger tool further includes a crank arm channel and in the stowed and manually operational positions the crank arm is at least partially disposed in the crank arm channel.

According to some embodiments, the body of the auger tool includes a feed hole. The extendable cable is fed into and out of the body through the feed hole. The body further includes a conical surface surrounding the feed hole. The body further includes a dam circumscribing the feed hole comprising a collar and one or more supports, such that the one or more supports and the collar create a planar surface.

According to some embodiments, the cable of the auger tool includes an end portion having an enlarged outer diameter and the end portion of the cable is angled relative to a remaining portion of the cable.

According to some embodiments, the cable of the auger tool includes at least one indicator for indicating a predetermined position of the cable relative to the body.

According to some embodiments, the auger tool further includes a Bellville washer disposed between the rotationally independent grip and the body.

According to some embodiments, the auger tool further includes a QR code.

According to some embodiments, an interior of the body of the auger tool includes a fastener and contains an end portion of the cable. The end portion of the cable comprises an enlarged outer diameter. The fastener is located a distance D1 from a sidewall of the interior of the body and D1 is smaller than the enlarged outer diameter. The cable is wound tangentially around the interior of the body. The cable is disposed between the fastener and the sidewall of the interior of the body.

According to some embodiments, an auger tool includes a body, an extendable cable stored in the body, a rotationally independent grip, and a crank assembly. The crank assembly includes a crank arm and a direct drive assembly. The crank arm is pivotably coupled to a center of the body and configurable in a stowed and manually operational position 180 degrees from the stowed position. The direct drive assembly includes a hex bit coupled to the center of the body and configured to receive rotational forces and transfer rotational forces to the body.

According to some embodiments, the direct drive assembly of the auger tool includes a chuck sleeve and a retainer plate. The hex bit is disposed in the chuck sleeve and the chuck sleeve is disposed in the body. The retainer plate is coupled to the hex bit and the body and the retainer plate is configured to transfer the rotational forces from the hex bit to the body.

According to some embodiments, the crank arm of the auger tool includes a cut-out permitting the crank arm to pivot over the direct drive assembly without interference.

According to some embodiments, the crank arm of the auger tool pivots between the stowed position and the manually operational position about an axis perpendicular to a centerline of the tool.

According to some embodiments, a method for clearing a clog in a tubular includes: providing an auger tool with a cable wound and stored in an interior body thereof, the interior body including a central aperture through which an end of the cable extends, the central aperture being surrounded by a dam structure shaped and configured to resist a potential energy of the wound and stored cable that tends to push at least some length of the cable out of the aperture so that, when the cable is not subject to an external force, the dam holds the at least some length of the cable within the interior body; inserting the end of the cable from the auger tool into the tubular by applying external force to the cable to overcome the resistance of the dam; pushing the cable along a path of the clogged tubular; reaching the clog in the tubular; rotating the cable by rotating the auger tool, thereby clearing the clog; and removing the cable from the tubular along with the clog.

According to some embodiments, the method further includes configuring a crank arm of the auger tool from a stowed position to a manually operational position. The manually operational position is 180 degrees from the stowed position pivoted about an axis perpendicular to a centerline of the auger tool and rotating the auger tool includes rotating the crank arm in the manually operational position.

According to some embodiments, the method further includes configuring the crank arm of the auger tool in the stowed position. The auger tool comprises a hex bit rotatably coupled to a body of the auger tool and rotating the auger tool includes applying rotational forces to a direct drive of the auger tool.

According to some embodiments, the method further includes axially fixing the cable with respect to the auger tool with a cable lock before rotating the cable.

According to some embodiments, the method includes rotating the auger tool by a power drill.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a perspective view of an auger tool, according to one embodiment;

FIG. 2A is a back perspective view of the auger of FIG. 1 with a handle thereof in a stowed position;

FIG. 2B is a back perspective view of the auger tool of FIG. 1 with the handle in a manually operational position;

FIG. 3A is a cross-sectional view of the auger tool of FIG. 1;

FIG. 3B is an exploded perspective view of an example hex bit and chuck of an optional direct drive assembly of the auger tool of FIG. 1, according to one embodiment;

FIG. 4 is a perspective view of a portion of the interior of the auger tool of FIG. 1;

FIG. 5A is a detailed cross-sectional view of a portion of a cable housing of the auger tool of FIG. 1 with a cable lock thereof in an unlocked position, according to one embodiment; and

FIG. 5B is a detailed cross-sectional view similar to FIG. 5A, with the cable lock in a locked position, according to one embodiment.

DRAWING REFERENCE NUMERALS
100—auger tool
110—tool body
111—feed hole
112—dam
113—bosses
114—cable attachment
115—fastener
116—recessed portion
120—cable
121—bulb shaped portion
122—end portion
130—grip
140—cable lock
150—crank assembly
151—crank handle
152—crank arm
153—pivotable coupling
154—arrow
155—crank arm channel
156—cut-out portion
157—nylon lock nut
158—crank handle opening
160—direct drive assembly
161—chuck sleeve
162—bit
163—retainer plate
170—cable housing
180—washer
181—indicator
182—symbol

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The disclosure contemplates that terms such as “couples,” “coupling,” “couple,” and “coupled” may include, but are not limited to, for example: welding, interference fitting, and/or fastening such as by using bolts, threaded connections, pins, clips, and/or screws. The disclosure contemplates that terms such as “couples,” “coupling,” “couple,” and “coupled” may include but are not limited to integrally forming. The disclosure contemplates that terms such as “couples,” “coupling,” “couple,” and “coupled” may include but are not limited to direct coupling and/or indirect coupling, such as indirect coupling through components such as links.

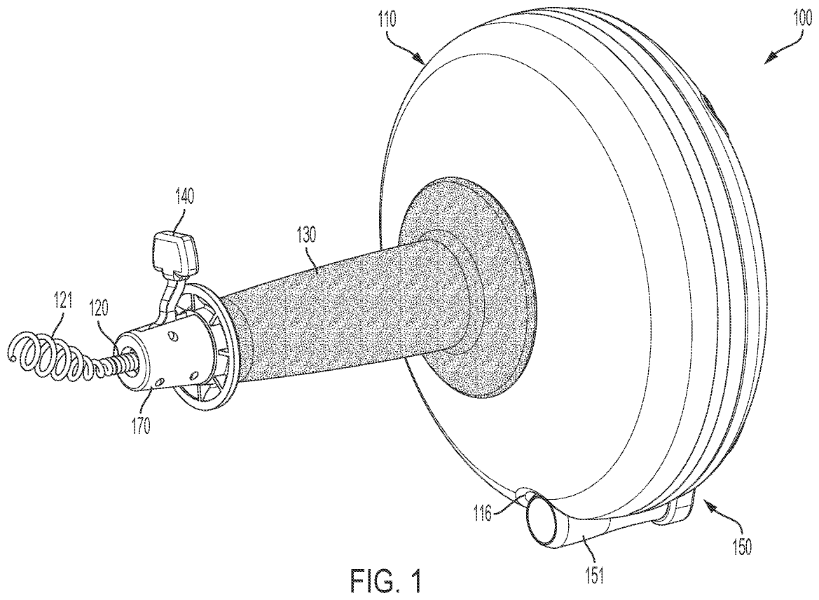

FIG. 1 is a perspective view of an auger tool 100 according to one embodiment. The primary parts of the tool 100 shown in FIG. 1 include: tool body 110 for housing extendable and retractable cable 120, grip 130, cable housing 170, cable lock 140, and crank assembly 150 (partially visible in FIG. 1).

The tool body 110 may be generally cylindrically shaped with rounded edges and semi-conical ends, and generally define an interior space to store the wound up cable 120. The tool body 110 may also be given a streamlined appearance to make the tool body 110 visually appealing. As discussed later, the tool body 110 may also include recesses and extrusions to accomplish desired capabilities of the auger tool 100.

The cable 120 is typically stored inside of the tool body 110. The cable 120 may be extended out of the cable housing 170 and retracted back into the cable housing 170. According to some embodiments, the cable 120 is manually extended and retracted as needed by a user. The cable 120 may be formed from a flexible, coiled metal. In some embodiments, the cable 120 may be 15 feet long; in some embodiments the cable 120 may be 25 feet long. However, the cable 120 may be any suitable length for desired applications that fits within the tool body 110 and works with the remaining components of the tool 100.

A distal end of the cable 120 includes a bulb-shaped portion 121 with an increased diameter compared to the main length of the cable 120. The bulb-shaped portion 121 may also be angled with respect to the adjacent portion of the cable 120. The bulb-shaped portion 121 may be angled 0 to 90 degrees with respect to the adjacent portion of the cable 120. The angle of the bulb-shaped portion 121 may allow for the cable to be pushed through tubular sections having a variety of turns, such as plumber's traps and other turns that are typically encountered in household plumbing, In the embodiment shown, the bulb-shaped portion 121 is angled 30 plus or minus 5 degrees with respect to the immediately adjacent portion of the cable 120. According to embodiments, the angle of the bulb-shaped portion 121 with respect to the immediately adjacent portion of the cable 120 may be optimized for its above-mentioned purposes. For example, through testing, the inventors have determined that the bulb-shaped portion 121 having an angle of 30 degrees plus or minus 5 degrees with respect to the immediately adjacent portion of the cable 120 is optimal for the cable 120 to bend, rotate and/or advance through the variety of turns commonly encountered in household plumbing systems.

A terminal end of the bulb-shaped portion 121 is configured to contact, engage and secure an obstruction in a tubular for removal via retraction of the cable 120. For example, as described further below, rotation of the cable 120 via the crank assembly 150 or the direct drive assembly 160 causes the terminal end of the bulb-shaped portion 121 to rotate and drive into the obstruction so that subsequent retraction of the cable 120 effectuates removal of the obstruction.

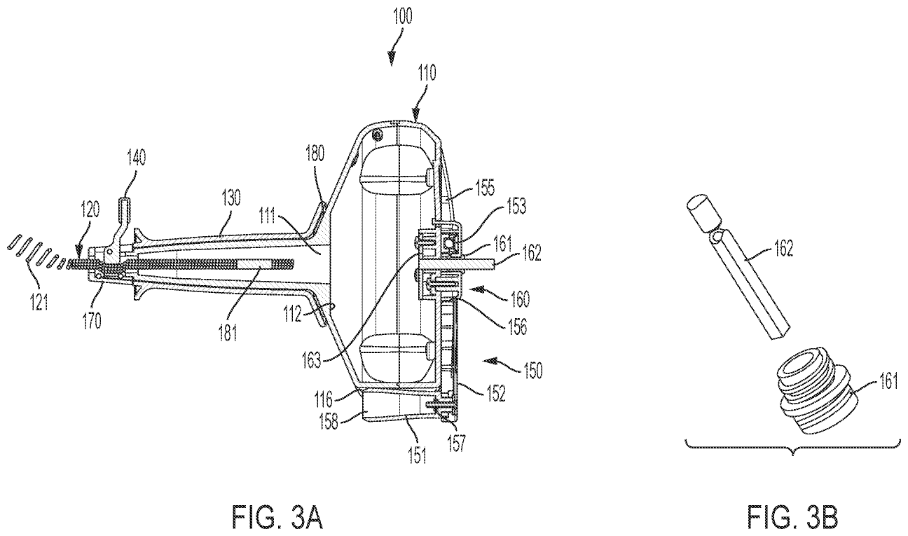

As depicted in the cross-section of FIG. 3A, the grip 130 is shown in a distinguishing shade to indicate it is rotationally independent of the other portions of the tool 100. The grip 130 in the example shown is contoured to be ergonomically sensitive and is constructed and arranged to be gripped by a user with one hand and be rotationally independent of the rotating body 110 and cable 120. That is, the user can hold and support the auger tool 100 with one hand via the grip 130. At the same time, the user can use their other hand to extend the cable 120 into a tubular such as a household plumbing drain until the bulb-shaped portion contacts an obstruction. As will be described further below, the user can then engage the cable lock 140 to rotationally lock the extended portion of the cable 120 relative to the body 110 and cable housing 170, proceed to rotate the body 110 and the cable 120 (via the crank assembly 150 or the direct drive assembly 160) to secure the obstruction, and then disengage the cable lock 140 for retraction of the cable 120 and removal of the secured obstruction. According to some embodiments, the entire operation may be conveniently accomplished with one hand continuously holding the ergonomic grip 130. The grip 130 is positioned around the axis of rotation of the tool body 110 at a relatively short radius away so that the rotational moment experienced by the user's hand holding the grip 130 is minimal during operation.

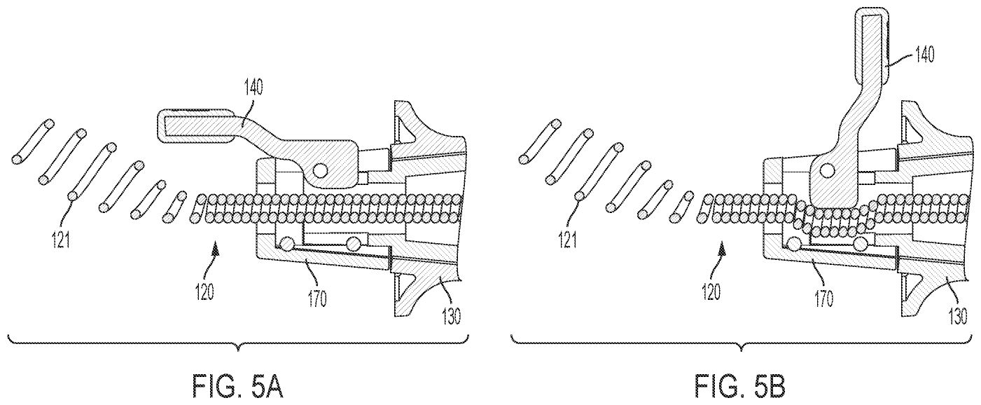

The cable 120 extends from the cable housing 170 adjacent to the grip 130. The cable housing 170 includes the cable lock 140 that includes a tab that can be moved from a locked position (FIG. 5B) to an unlocked position (FIG. 5A). The tab of the cable lock 140 may be coated in a protective material, such as a rubber or other elastomeric material, to prevent damage to things that may contact the tab, and for user comfort. Further discussion of the cable lock 140 and its operation can be seen below in the detailed description of FIG. 5A-5B.

FIG. 1 illustrates the crank assembly 150 (partially visible) shown in a stowed position. In the stowed position, a handle 151 of the crank assembly 150 is nested in a semicircular recess 116 in a part of the outer circumference of the tool body 110.

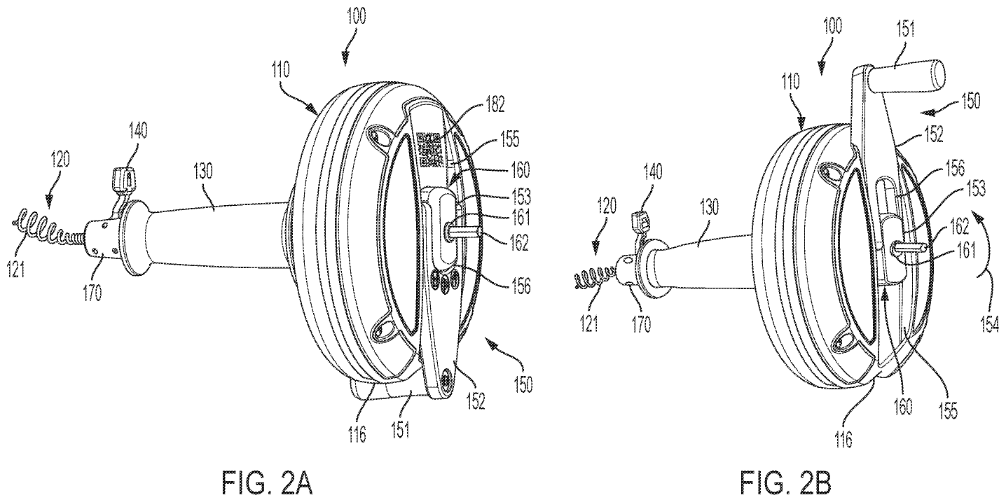

FIGS. 2A-2B illustrate another perspective view of the auger tool 100. As described above and further detailed below, the tool 100 is configured for manual operation wherein the grip 130 is held in one hand and the body 110 (and cable 120) is rotated about its center axis by hand using, for example, the crank assembly 150 located at the backside of the body 110. According to an optional embodiment detailed further below, the body 110 (and cable 120) can also be rotated about the center axis using a power accessory such as a drill connected to the direct drive assembly 160.

The crank assembly 150 includes handle 151, crank arm 152, and pivotable coupling 153. In an optional embodiment, the direct drive assembly 160 is positioned on a top surface of the body 100, on a rotational axis thereof. The crank arm 152 is pivotably coupled to the tool body 110 via pivotable coupling 153. The pivotable coupling 153 allows the crank arm 152 to pivot 180 degrees (as shown by the arrow 154) from the stowed position (as shown in FIG. 2A) wherein the handle 151 is stowed in the semi-circular recessed portion 116 of the tool body 110 to a manually operational position (as shown in FIG. 2B) wherein the crank handle 151 extends axially from the rear of the tool body 110 and allows for a user to grip the crank handle 151. The crank arm 152 is pivotable about an axis perpendicular to the centerline of the tool 100. That is, the crank arm 152 is pivotable about an axis perpendicular to the axis of rotation of the tool 100.

When the handle 151 is in the stowed position, the handle 151 is generally positioned at the outer circumference of the body 110 within the recess. Accordingly, when in the stowed position shown in FIG. 2A, the handle 151 does not interfere with, for example, rotation of the body 110 (and cable 120) when using a power accessory such as a drill connected to the direct drive assembly 160. Additionally, when the handle 151 is in the stowed position shown in FIG. 2A, the auger tool 100 has a reduced total footprint compared to, for example, when the handle 151 is in the manually operable position, which allows for easier transport and storage by manufacturer, retailer, and end user alike.

As shown, the tool body 110 further includes a crank arm channel 155 extending from one end to the other of the tool body 110. The crank arm channel 155 receives the crank arm 152 in both the stowed position shown in FIG. 2A and the manually operational position shown in FIG. 2B.

In the stowed position as shown in FIG. 2A, the crank arm 152 is at least partially recessed in the crank arm channel 155, also resulting in a more streamlined appearance and a smaller overall footprint of the tool 100. Additionally, the low profile created by the stowed crank assembly 150 reduces the chance it will interfere when the tool 100 is operated in a power mode, as discussed herein.

In the manually operational position as shown in FIG. 2B, the crank arm 152 is also at least partially recessed in the crank arm channel 155, again resulting in a more streamlined appearance of the tool 100. Also, the sidewalls of channel 155 also acts to receive forces applied by the user to the crank arm 152 so that such forces (e.g., torque and the related moment of force applied to the components of tool 100) are transferred to the tool body 110. The channel 155 therefore alleviates the force that would otherwise be acting solely on the pivotable coupling 153. Further, in the manually operational position, the crank arm 152 extends beyond the body 110 for gripping by the user. That is, the crank arm 152 and handle 151 extend radially beyond the outer circumference of the tool body 110, allowing for greater torque to be applied to the tool body 110 in manual operation while the associated moment of force is distributed through the sidewalls of channel 155 to the tool body 110 (and not solely on the pivotable coupling 153).

The crank arm 152 further includes a “cut-out” portion 156 permitting the crank arm 152 to avoid interfering with the tool body 110 and, in some embodiments, the direct drive assembly 160, when moving between the stowed and manually operational positions. According to one embodiment, the cut-out portion 156 is U-shaped.

A portion of the optional direct drive assembly 160 is shown in FIGS. 2A-2B. In embodiments that include the direct drive assembly 160, the direct drive assembly 160 permits for powered operation of the tool 100. The direct drive assembly 160 includes a chuck sleeve 161, a bit 162 (which may be hex-shaped, and a retainer plate (such as retainer plate 163 of FIG. 3A). The direct drive assembly 160 is at least partially housed in an extrusion on the tool body 110 that also houses the pivotable coupling 153 (e.g., within the crank arm channel 153). In more embodiments not having the direct drive assembly 160, the extrusion may still be present in the tool body 110. For example, the extrusion provides a mounting structure for coupling the crank arm 152 to the tool body 110 via pivotable coupling 153, with or without the direct drive assembly 160. The tool 100 may be power operated in the stowed position or the manually operational position. Operating the tool in power mode involves gripping the drill (rather than the crank handle 151 or arm 152) in one hand while gripping the rotationally independent grip 130 in the other hand, securing the exposed shank of the hex-shaped bit 162 into the chuck of the drill (not shown), and using the drill to rotate the hex-shaped bit 162 and, by extension, the body 110 and the cable 120.

The chuck sleeve 161 of the direct drive assembly 160 is positioned in an aperture in the center of an upper surface of the tool body 110. The chuck sleeve 161 may have, for example, a hex-shaped inner diameter constructed and arranged to mate with the hex-shaped bit 162 of the direct drive assembly 160. The bit 162 partially extends from the chuck sleeve 161 and the tool 100 to receive the chuck of a drill (not pictured). The direct drive assembly 160 receives rotational power from the drill (not pictured) and transfers the rotational power through the hex bit 162, the chuck sleeve 161, and through the retainer plate to rotate the tool body 110.

In some embodiments, the rear portion of the tool body 110 includes a symbol 182, such as, for example, a QR code. This symbol 182 may be printed onto the tool body 110 or may be attached as a sticker or by adhesives. The symbol 182 allows users to utilize an external device, such as a smartphone, to immediately and easily access “How to” videos and other helpful materials stored online.

FIG. 3A illustrates a cross sectional view of the tool 100, according to one or more embodiments. FIG. 3A again illustrates the tool 100 with the crank handle 151 in the stowed position in the recess 116 of the tool body 110. The crank handle 151 also is rotatably connected to the crank arm 152 such that the crank handle 151 may rotate independently from the crank arm 152. In the illustrated embodiment, this is accomplished by a press fit nylon lock nut 157 installed into the crank handle 151 coupling the crank handle 151 to the crank arm 152.

In some embodiments, the crank handle 152 can be used as an alternative storage for the bit 162. In such embodiments, the crank handle 151 is provided with an opening 158 at its distal end. In such embodiments, the opening 158 is used to store the bit 162. The bit 162 may be coupled to the chuck sleeve 161 (as shown in FIG. 3B) that retains one end of the bit 162 in a press fit relationship. The bit 162 and chuck sleeve 161 can be inserted into the opening 158 formed in the handle 151 via a threaded relationship between the chuck sleeve 161 and an interior of the handle 151. The result is a bit 162 for power mode that can be completely housed in the handle when, for example, the tool 100 is used manually.

The tool 100 further includes a friction reducing washer 180 between the body 110 and the grip 130, here a Bellville washer. The washer 180 is positioned between the tool body 110 and the grip 130. The Bellville washer 180 is made of metal and provides a barrier between the two independently moving components. The Bellville washer 180 reduces friction between the grip 130 and the tool body 110 and provides increased durability of the surfaces of the grip 130 and tool body 110 that would otherwise be in direct sliding contact with one another.

The aforementioned retainer plate 163 of the direct drive assembly 160 is also shown in FIG. 3A. As stated previously, the retainer plate 163 is rotationally fixed to the hex bit 162 and the tool body 110 such that when the hex bit 162 is rotated, the body 110 is also rotated. Thus, when the tool 100 is power operated, the hex bit 162 is rotated and that rotation is transferred to the tool body 110 by the retainer plate 163.

A portion of the cable 120 is shown in FIG. 3A. As shown, the cable 120 further includes an indicator 181 for advising a user how much or little of the cable is extending from the body 110. One embodiment of an indicator 181 is illustrated. In the embodiment shown, the indicator 181 is located one foot from the bulb-shaped portion 121 of the cable 120 to warn a user, as the cable 120 is being withdrawn from a tubular member like a pipe or other structure with a clog, that the bulb 121 (and likely remains of an obstruction attached thereto) is nearing the surface. In the embodiment shown, the indicator 181 is about a 1 inch portion of cable 120 having a distinguishable color or shade, but it will be understood that the indicator 181 could be anything that is attention-getting, such a different finish of the cable, a different diameter of the cable or even series of closely spaced colors or shapes. For example, in one embodiment, each of the last 5 feet of the cable 120 may be provided with indicators 181, with each of the indicators 181 separated into closely spaced portions corresponding to the number of feet extending from the body 110.

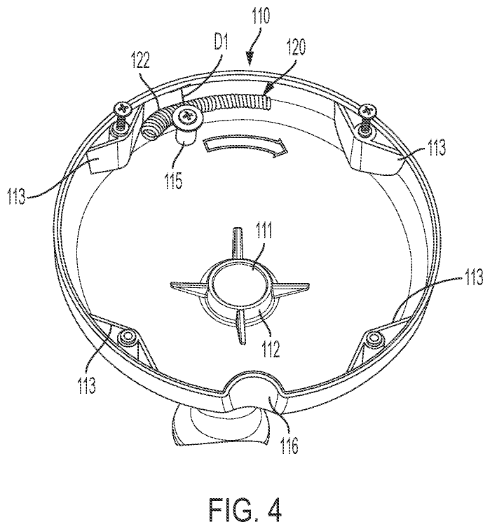

FIG. 4 illustrates an internal space of the tool body 110. The tool body 110 includes a feed hole 111, also referred to herein as an aperture. The feed hole 111 is located at the center of the body 110, is surrounded by a conical surface (i.e., dam 112 described below), and is configured to guide the cable 120 (only a portion of cable 120 is shown in FIG. 4) out of the tool body 110 and out of the tool 100 through the cable housing (such as cable housing 170 of FIG. 1). When not in operation, the cable 120 is wound around the interior of the tool body 110. A small portion of the cable 120 is illustrated to depict how the cable 120 is wound around the interior surface of the tool body 110 toward the feed hole 111.

The body 110 further includes dam 112. The dam 112 is located at the center of the tool body 110 circumscribing the feed hole 111. The dam 112 has a raised collar and four supports extending radially from the collar and in the shape of an “X.” The supports are shaped such that there is a flat plane from one end of the “X” to the other (this can be seen in FIG. 3A). The dam 112 is sufficiently tall enough so as to prevent the cable from springing through the feed hole 111 due to stored potential energy in the cable 120 and the slant in the tool body 110. That is, the cable 120 has some potential energy when stored in the tool body 110 by virtue of, for example, being a coiled member arranged in a wound-up position inside the generally closed tool body 110. Accordingly, the dam 112 is shaped and configured to hold the cable 120 in place until a user pulls on and deploys the cable 120.

Also included on the interior of the body 110 are four rounded bosses 113 containing screw holes that receive the screws that connect the two pieces of the tool body 110 together. The bosses 113 have sides with a small angle relative to tangents of the interior circumference, the sides isolating the screw holes from the rest of the interior of the body 110. The angles of the sides of the bosses 113 permits the cable 120 to glide around the screw holes without getting hung up, thereby ensuring proper operation of the tool 100.

As stated previously, a portion of the cable 120 is shown in FIG. 4. More specifically, the cable attachment 114 is shown. The attachment 114 includes an end portion 122 of the cable 120 and a fastener 115. The end portion 122 of the cable 120 is wound tangentially with the shape of the body 110 and is squeezed between the fastener 115 and the side wall of the body 110. The end portion 122 of the cable 120 has a larger diameter than the majority of the cable 120 (in some embodiments, larger than all portions of the cable 120 other than the bulb-shaped portion 121). The fastener 115 is positioned within the interior of the tool body 110 to be a distance D1 from the side wall. The distance D1 is less than the diameter of the end portion 122 of the cable 120. Thus, the end portion 122 of the cable 120 is not permitted to pass by the fastener 115, and thereby the cable 120 is secured within the tool body 110. As can be seen in FIG. 4, the fastener 115 secures the cable 120 to the interior of the tool body 110 substantially tangential to the circumference of the tool body 110. This tangential connection of the cable 120 to the interior of the tool body 110 provides improved coiling (i.e., retraction) of the cable 120 when being manually retracted, especially compared to a radial connection such as, for example, with a fastener near an outer portion of the interior of the tool body 110 extending through a loop at the end of the cable 120, which would tend to position the end of the cable 120 radially when the cable 120 is fully extended. That is, according to embodiments of the present disclosure, when the cable 120 is fully deployed and the user begins to retract the cable 120 into the tool body 110, the cable 120 is initially “trained” to spiral within the interior of the tool body 110 as user pushes the cable 120 into the tool 100, due to the tangential connection of the cable 120 to the interior of the tool body 110.

FIGS. 5A-5B illustrate a detailed cross-sectional view of a portion of the cable housing 170. FIG. 5A illustrates the cable lock 140 in the unlocked position and FIG. 5B illustrates the cable lock 170 in the locked position.

As described herein, the cable housing 170 includes cable lock 140. In the unlocked position, illustrated in FIG. 5A, the cable 120 is permitted to rotate within and axially move in and out of the cable housing 170. In the locked position, illustrated in FIG. 5B, the cable 120 is permitted to rotate within the cable housing 170 but is axially fixed relative to the tool body 110.

The cable lock 140 utilizes a cam mechanism to axially fix the cable 120. The tab of the cable lock 140 is movable from the unlocked (horizontal) to the locked position (vertical). In the locked position, the end of the tab disposed within the cable housing 170 pinches the cable 120 with the other end of the cable housing 170.

In some embodiments, an alternative mode of storage for the hex bit 162 consists of installing the hex bit 162 into a clip formed on a rear surface of the body 110. The clip permits the bit to be stored in a manner that prevents interference when the tool 100 is used manually.

In some embodiments, the crank assembly 150 may alternatively consist of the crank handle 151 that is movable between an operable (vertical) and stowed (horizontal) position and arranged in a manner wherein the handle is spring-biased to remain in either position.

Still, in other embodiments, the crank handle 151 also serves as an adaptor for use in a power mode. In such embodiments, the crank handle 151 includes a quick release member at a first end for easy attachment to an outer edge of the rear portion of the body 110 or attachment as a power adapter extending from the center of the rear portion of the body 110. In such embodiments, the other end may comprise the bit 162 for receiving power, such as from the chuck of a drill (not shown). Quick release adaptors are well known in the art and typically include a spring loaded collar that can be retracted against a biasing spring and then released for connection to a mating member. In its manually operational position, the handle 151 is attached to the outer edge of the rear portion of the body 110 by the quick release adaptor such that it is located similarly to the handle 151 in embodiments previously discussed. This configuration permits the handle portion to be manipulated to rotate the tool body and cable. In its stowed and power operated position, the handle 151 is attached to the center of the rear portion of the body 110 and is configured to receive the chuck of a drill (not shown).

As the foregoing illustrates, the disclosure includes an auger tool having improved features that result in an easy-to-use tool with ergonomic and convenient features and a pleasing appearance.

It is contemplated that one or more of these aspects disclosed herein may be combined. Moreover, it is contemplated that one or more of these aspects may include some or all of the aforementioned benefits.

As an example, the present disclosure contemplates that one or more of the aspects, features, components, operations, and/or properties described herein may be included in the auger tool 100 and/or methods of using the auger tool 100.

It will be appreciated by those skilled in the art that the preceding embodiments are exemplary and not limiting. It is intended that all modifications, permutations, enhancements, equivalents, and improvements thereto that are apparent to those skilled in the art upon a reading of the specification and a study of the drawings are included within the scope of the disclosure. It is therefore intended that the following appended claims may include all such modifications, permutations, enhancements, equivalents, and improvements. The present disclosure also contemplates that one or more aspects of the embodiments described herein may be substituted in for one or more of the other aspects described. The scope of the disclosure is determined by the claims that follow.

What is claimed is:

1. An auger tool comprising:
a body comprising a semi-circular recess;
an extendable cable stored in and rotatable with the body;
a rotationally independent grip; and
a crank assembly comprising:
a crank arm coupled by a pivotable coupling to a center of the body and configurable in a stowed position and a manually operational position; and
a crank handle coupled to the crank arm, wherein the crank arm is in the stowed position when the crank handle is disposed in the semi-circular recess of the body and the crank arm is in the manually operable position when the crank arm is pivoted 180 degrees from the stowed position and the crank handle extends axially from the body.

2. The auger tool of claim 1, wherein the crank assembly further comprises a direct drive assembly comprising a hex bit disposed in a chuck sleeve and coupled to a retainer plate configured to receive rotational forces and transfer the rotational forces to the body.

3. The auger tool of claim 2, wherein:
the direct drive assembly is disposed in the center of the body; and
the crank arm comprises a cut-out permitting the crank arm to pivot over an extrusion of the body housing the pivotable coupling and the direct drive assembly without interference.

4. The auger tool of claim 1, wherein the crank arm pivots between the stowed position and the manually operational position about an axis perpendicular to a centerline of the auger tool and wherein the crank arm extends beyond an outer diameter of the body when the crank assembly is in the manually operational position.

5. The auger tool of claim 1, wherein the body further comprises a crank arm channel and in the stowed and manually operational positions the crank arm is at least partially disposed in the crank arm channel.

6. The auger tool of claim 1, wherein the body comprises:
a feed hole, wherein the extendable cable is fed into and out of the body through the feed hole;
a conical surface surrounding the feed hole; and
a dam circumscribing the feed hole comprising a collar and one or more supports, such that the one or more supports and the collar create a planar surface.

7. The auger tool of claim 1, the cable comprising an end portion having an enlarged outer diameter, wherein the end portion of the cable is angled relative to a remaining portion of the cable.

8. The auger tool of claim 1, wherein the cable includes at least one indicator for indicating a predetermined position of the cable relative to the body.

9. The auger tool of claim 1, wherein the auger tool further comprises a Bellville washer disposed between the rotationally independent grip and the body.

10. The auger tool of claim 1, wherein the auger tool further comprises a QR code.

11. The auger tool of claim 1, wherein an interior of the body comprises a fastener and contains an end portion of the cable, wherein:
the end portion of the cable comprises an enlarged outer diameter;
the fastener is located a distance D1 from a sidewall of the interior of the body, wherein D1 is smaller than the enlarged outer diameter;
the cable is wound tangentially around the interior of the body; and
the cable is disposed between the fastener and the sidewall of the interior of the body.

12. An auger tool, comprising:
a body;
an extendable cable stored in the body;
a rotationally independent grip; and
a crank assembly comprising:
a crank arm pivotably coupled to a center of the body and configurable in a stowed and manually operational position 180 degrees from the stowed position; and
a direct drive assembly comprising:
a hex bit coupled to the center of the body and configured to receive rotational forces and transfer rotational forces to the body.

13. The auger tool of claim 12, wherein the direct drive assembly further comprises:
a chuck sleeve, wherein the hex bit is disposed in the chuck sleeve and the chuck sleeve is disposed in the body; and
a retainer plate coupled to the hex bit and the body, the retainer plate is configured to transfer the rotational forces from the hex bit to the body.

14. The auger tool of claim 12, wherein the crank arm comprises a cut-out permitting the crank arm to pivot over the direct drive assembly without interference.

15. The auger tool of claim 12, wherein the crank arm pivots between the stowed position and the manually operational position about an axis perpendicular to a centerline of the tool.

16. A method for clearing a clog in a tubular, comprising:
providing an auger tool with a cable wound and stored in an interior body thereof, the interior body including a central aperture through which an end of the cable extends, the central aperture being surrounded by a dam structure shaped and configured to resist a potential energy of the wound and stored cable that tends to push at least some length of the cable out of the aperture so that, when the cable is not subject to an external force, the dam holds the at least some length of the cable within the interior body;
inserting the end of the cable from the auger tool into the tubular by applying external force to the cable to overcome the resistance of the dam;
pushing the cable along a path of the clogged tubular;
reaching the clog in the tubular;
rotating the cable by rotating the auger tool, thereby clearing the clog; and
removing the cable from the tubular along with the clog.

17. The method of claim 16 further comprising configuring a crank arm of the auger tool from a stowed position to a manually operational position, wherein:
the manually operational position is 180 degrees from the stowed position pivoted about an axis perpendicular to a centerline of the auger tool; and
rotating the auger tool comprises rotating the crank arm in the manually operational position.

18. The method of claim 17 further comprising configuring the crank arm of the auger tool in the stowed position, wherein the auger tool comprises a hex bit rotatably coupled to a body of the auger tool and rotating the auger tool comprises applying rotational forces to a direct drive of the auger tool.

19. The method of claim 16, further comprising:
axially fixing the cable with respect to the auger tool with a cable lock before rotating the cable.

20. The method of claim 18, wherein the auger tool is rotated by a power drill.
